(19) United States
(12) Patent Application Publication
(10) Pub. No.: US 2014/0222330 A1
(43) Pub. Date: Aug. 7, 2014

(54) INTEGRATION OF CONTEXTUAL AND HISTORICAL DATA INTO ROUTE DETERMINATION

(71) Applicants: Tobias M. Kohlenberg, Portland, OR (US); Rita H. Wouhaybi, Portland, OR (US); Stanley Mo, Portland, OR (US); Mubashir A. Mian, Morton Grove, IL (US)

(72) Inventors: Tobias M. Kohlenberg, Portland, OR (US); Rita H. Wouhaybi, Portland, OR (US); Stanley Mo, Portland, OR (US); Mubashir A. Mian, Morton Grove, IL (US)

(21) Appl. No.: 13/997,719

(22) PCT Filed: Dec. 27, 2011
(86) PCT No.: PCT/US11/67427

§ 371 Date: Apr. 9, 2014

(51) Int. Cl. G01C 21/34

(52) U.S. Cl. CPC G01C 21/3484
USPC 701/425

(57) ABSTRACT

Generally, this disclosure describes a method and system for route personalization. A method may include, in an embodiment, requesting that a user of a computing device provide a trip modifier in response to a request from the user to map a route from a first location to a second location; acquiring objective data related to the trip modifier for at least one possible route from the first location to the second location; generating a weighted route recommendation associated with each possible route based on the acquired objective data and the trip modifier; and displaying each possible route and its associated weighted route recommendation on the computing device, wherein the trip modifier comprises at least one user characteristic and each weighted route recommendation is configured to provide a personalized route recommendation to the user for the respective associated possible route.

### FIELD

This disclosure relates to route determination, more particularly to integration of contextual and historical data into route determination.

### BACKGROUND

Today, when a person uses a travel route determination application (“mapping app”), the user typically must evaluate whether the determined route is the best route for him or her based on, for example, time of year, day of week, and/or other factors. Mapping apps typically provide only limited routing options such as shortest distance, shortest time, avoid tolls and/or avoid freeways. A user who wishes to evaluate a determined route in a more personalized manner may then ask others, for example, friends and/or members of his or her social network for further information and recommendations regarding route choice. Such further information and recommendations may not be available or may be available but may not provide the desired guidance. In other words, recommendations from the social network may not yield an optimum route for a particular user.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a route personalization system consistent with various embodiments of the present disclosure;

FIG. 2 illustrates a flow chart of exemplary operations of a user device consistent with various embodiments of the present disclosure; and

FIGS. 3, 4 and 5 illustrate an example of route personalization consistent with various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure describes a method and system for route personalization. The method and system are configured to integrate contextual and historical data into route determinations. The method and system are configured to provide weighted recommendations regarding a travel route to a user based on user-provided trip modifier(s) and a plurality of objective data. The trip modifiers may include, but are not limited to, trip characteristics, user characteristics, user prioritized travel factors and vehicle characteristics. The objective data may include, but is not limited to, traffic data, crime data, accident data, weather data, geographic data, specialty data, and/or other objective data. The objective data may include historical, current and/or future (predicted or planned) data.

The user may request a map of a route for travel from a first (starting) location to a second location (destination), for example, on a user device. The user device may be any computing device, as described herein. The user may launch a routing application configured to generate one or more possible routes between the first location and the second location. The user may also launch a route personalization app configured to generate weighted recommendations for each route generated by the routing app. The user may be asked to provide trip modifier(s) for the trip. Objective data may then be acquired based on the trip modifier(s) for the possible route(s) generated by the routing app. The objective data may then be analyzed based on the trip modifier(s) for each possible route. Weighted route recommendation(s) may then be generated for each possible route based on the acquired objective data and the trip modifier(s). The route(s) and weighted recommendation(s) may then be displayed to the user via the user device.

The user may select how the weighted recommendations are displayed using display preferences. For example, routes may be color-coded according to relative weights (for example, better route highlighted green, poorer route highlighted red), routes and/or locations on a route corresponding to a prioritized travel factor may be indicated symbolically and/or data corresponding to the weighted recommendations may be displayed (e.g., a snowflake symbol and/or the likelihood a user might encounter inclement weather may be displayed if the user indicated avoiding inclement weather as a high priority). The user may then select a personalized route based on the weighted recommendations.

Thus, a method and system consistent with the present disclosure is configured to provide a personalized route recommendation to a user based on trip modifiers (e.g., user-prioritized travel factors, user characteristics, trip characteristics) and objective data. The user-prioritized travel factors reflect the user's risk tolerance for specific travel factors for this trip. The acquisition and analysis of the objective data based on the trip modifiers are transparent to the user. The user's risk tolerance is thus incorporated into the weighted recommendations, resulting in recommendations personalized for the user.

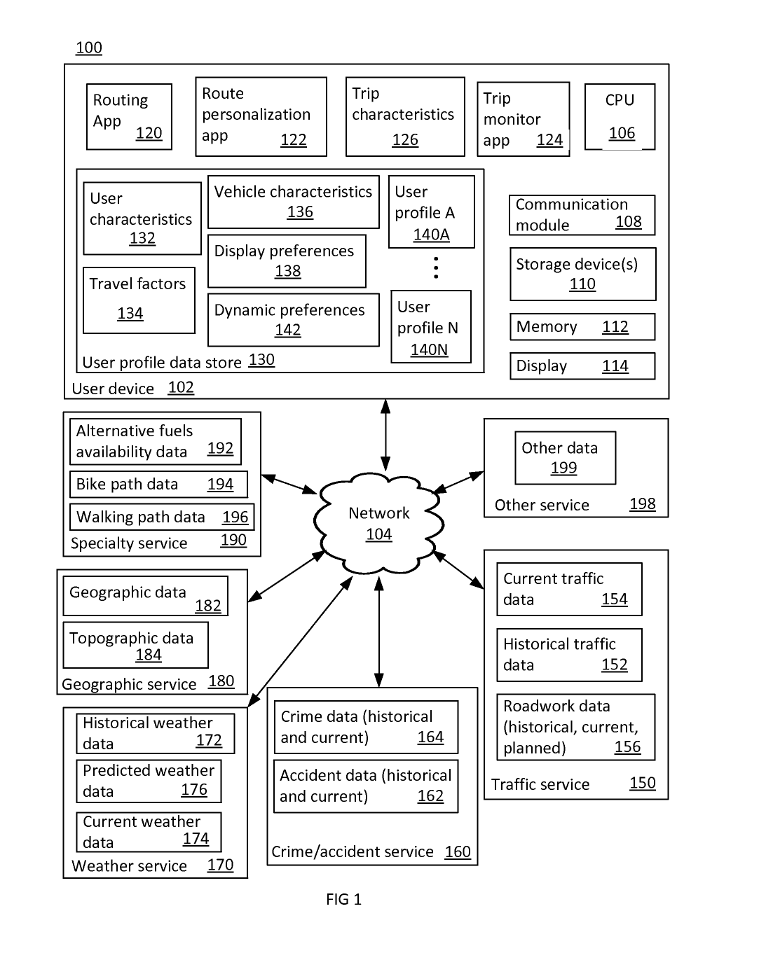

FIG. 1 illustrates a route personalization system 100 consistent with various embodiments of the present disclosure. The system 100 generally includes a user device 102, network 104 and a plurality of objective data services 150, 160, 170, 180, 190, 198. “User device” as used herein means any computing device, including, but not limited to, mobile telephones, smartphones, tablet computers, notebook computers, laptop computers, ultraportable computers, ultramobile computers, netbook computers, subnotebook computers, personal digital assistants, enterprise digital assistants, mobile internet devices, personal navigation devices and other computing devices. The objective data services may be included in one or more dedicated servers and/or may correspond to web-based services processing on one or more generalized servers (e.g., cloud computing). The user device is configured to access the objective data services via network 104. Network 104 may include public and/or private networks, wired and/or wireless. For example, network 104 may include the Internet, a cellular telephone network and/or other networks.

User device 102 includes at least one processor “CPU” 106, a communication module 108, one or more storage device(s) 110, memory 112 and a display 114. CPU 106 is configured to perform one or more operations associated with applications (“apps”), as described herein. Communication module 108 is configured to provide wireless and/or wired connectivity for user device 102 to network 104 and/or objective data service(s) 150, 160, 170, 180, 190 and/or 198. Communication module 108 is configured to communicate via one or more communication protocols, as described herein. Storage device(s) 110 are configured to store one or more applications, data and/or characteristics and may include any type of tangible storage medium, as described herein. Memory 112 is configured to store one or more applications and/or characteristics and may include any type of memory as described herein. Display 114 is configured to display a map including at least one route and personalized route recommendation indicators to a user as described herein.

User device 102 includes a routing app 120, a route personalization app 122, trip characteristics 126 and a user profile data store 130 and may include a trip monitor app 124. Although routing app 120 and trip monitor app 124 are shown as separate from the route personalization app 122, routing app 120 and/or trip monitor app 124 may be included in route personalization app 122. The routing app 120 is configured to generate a route in response to a user request to map a route from a first (start) location to at least one destination. The user may launch routing app 120 and may provide the starting location and one or more destinations to routing app 120. Routing app 120 may then generate one or more possible routes corresponding to the starting location and the destination(s). For example, routing app 120 may correspond to a freely available routing app, e.g., Google Maps or Yahoo! Maps, and/or may be a dedicated routing app included in route personalization app 122.

The user profile data store 130 is configured to store user data that route personalization app 122 may use to generate and display weighted route recommendations. User data includes user characteristics 132, travel factors 134, vehicle characteristics 136, display preferences 138, one or more user profiles 140A, . . . , 140N and may include dynamic preferences 142. User characteristics 132 may include, but are not limited to, age, ethnicity, sex, socioeconomic status (e.g., income, education, occupation), self-characterization of risk tolerance (e.g., risk taker vs. risk averse), traffic violation history and/or other user characteristics. Travel factors 134 may include, but are not limited to, safety, travel time, travel distance, likelihood of criminal activity, likelihood of travel delays, likelihood of inclement weather, risk of accident, frequency of traffic stops and/or other travel factors. Each travel factor may have a corresponding priority indicator. A default corresponding priority indicator may be included in travel factors 134. The user may override the default priority indicators (i.e., prioritize the travel factors) and store the user-defined priority indicator in, for example, a user profile. The prioritized travel factors are configured to reflect the user's risk tolerance and to provide a basis for route personalization as described herein. The prioritized travel factors are related to the objective data and analysis of the objective data, as described herein.

Vehicle characteristics 136 may include, but are not limited to, make, model, color, type and year of manufacture of vehicle. Vehicle types include, but are not limited to, commuter vehicle, family vehicle, sports car, truck, recreational vehicle (“RV”), motorcycle, bicycle, alternative fuel vehicle, hybrid vehicle and/or other vehicle types. Vehicle characteristics 136 may further include whether the vehicle is a standard shift or has an automatic transmission and whether the vehicle will be towing a trailer. For example, a weighted route recommendation may be configured to exclude narrow roads when the vehicle characteristics correspond to an RV. In another example, routes with steep hills may be excluded when the vehicle is towing a trailer.

Display preferences 138 are configured to manage how weighted route recommendations are displayed on display 114. For example, different route recommendations may be displayed using different colors. The colors may be configured to indicate a degree to which a route has satisfied user preferences (as indicated in a user profile) for the trip. In another example, relatively higher priority travel factors may be indicated along the route using symbols. In another example, at least some of the analysis results (based on the objective data) used to generate the weighted route recommendations may be displayed along with the associated route. Thus, a user may configure display of weighted route recommendations via display preferences 138.

Dynamic preferences 142 are configured to allow a user to selectively over-ride previously selected and prioritized travel factors if, for example, an unexpected detour has become necessary. Dynamic preferences 142 may configured to re-order prioritizations associated with travel factors that may be included in a user profile and/or travel factors 134. For example, a user that typically prioritizes avoiding an area with higher crime statistics above all other objective data may select as a dynamic preference allowing travel through a relatively high crime area if an alternative route would introduce a delay of greater than a defined threshold.

User profiles 140A, . . . , 140N are configured to indicate user characteristics, selected and prioritized travel factors, selected vehicle characteristics, selected display preferences and selected dynamic preferences. A user may store a plurality of user profiles 140A, . . . , 140N where each user profile corresponds to a respective prioritized subset of user data stored in the user profile data store 130. The prioritizations are configured to drive the analysis of relevant objective data and generation of weighted route recommendations so that possible routes that correspond to the user's priorities (and thus the user's risk tolerance) are afforded relatively higher weights. The user profiles 140A, . . . , 140N are configured to allow a user to store selected user profiles so that the user will not need to re-enter the information each time he/she requests a particular route personalization. For example, a user may establish a plurality of user profiles 140A, . . . , 140N, with each profile corresponding to a specific subset of prioritized travel factors, preferences and characteristics.

For example, a first user profile 140A may correspond to commuting. The first user profile 140A may be configured to indicate vehicle characteristics associated with the user's commuter vehicle. The first user profile 140A may be further configured to indicate prioritized selected travel factors associated with commuting. For example, the prioritized travel factors may be configured to assign relatively higher priorities to travel time and frequency of traffic stops or to selecting a scenic route if traffic congestion cannot be avoided. In another example, a second user profile 140B may correspond to family vacation travel to an unknown area. In this example, the prioritized selected travel factors associated with the second user profile 140B may be configured to assign a relatively higher priority to safety, reduced likelihood of criminal activity and reduced likelihood of an accident. The second user profile 140B may further indicate vehicle characteristics associated with the family vehicle and whether the family vehicle is towing a trailer.

Thus, user profile data store 130 is configured to store travel factors, various preferences and characteristics defined by a user. The user profile data store 130 is further configured to store a plurality of user profiles 140A, . . . , 140N, with each user profile corresponding to a specific prioritized subset of travel factors, preferences and characteristics. The specific user profiles may then be used to generate weighted route recommendations as described herein. Prioritizing travel factors is configured to ensure that weighted route recommendations reflect the user's priorities (and risk tolerance) for a particular trip. The selected travel factors and relative priorities, user characteristics and vehicle characteristics are configured to be used in the analysis of relevant objective data. Results of the analysis may then correspond to weighted route recommendations and route personalization as described herein.

Route personalization app 122 is configured to generate weighted route recommendations associated with each possible route generated by routing app 120. The weighted route recommendations may be generated based on trip modifiers (trip characteristics 126 and user data stored in user profile data store 130 (including prioritized travel factors)) and objective data acquired from one or more objective data services 150, 160, 170, 180, 190, 198. Trip characteristics 126 include mode of travel, date of travel, anticipated time of day of travel (if travel is future), type of travel and/or other trip characteristics. Modes of travel include any ground travel, including but not limited to, driving, walking, running, cycling (e.g., bicycle or motorcycle) and public transit (e.g., taxi, bus, train or subway). Types of travel include, but are not limited to, commuting, business travel, pleasure travel, vacation travel and miscellaneous travel. Types of travel may further include, leisure (e.g., walking or bicycling), exercise (e.g., walking, running or bicycling). Date of travel is configured to provide day of week, time of year, seasonal and holiday (or not holiday) information. Trip characteristics 126 may be used by route personalization app 122 when analyzing the objective data.

Objective data includes a variety of databases included in a variety of objective data services 150, 160, 170, 180, 190, 198. The objective data may be available from a variety of publicly available information resources such as government entities and television and radio stations. The objective data services 150, 160, 170, 180, 190, 198 are configured to provide historical, current and future (predicted or planned) objective data that the route personalization app 122 may acquire and may analyze. The route personalization app 122 may then generate weighted route recommendations based on the trip modifiers and the objective data, as described herein. The objective data services include a traffic service 150, a crime/accident service 160, a weather service 170, a geographic service 180, a specialty service 190 and may include an other service 198.

The traffic service 150 may include historical traffic data 152, current traffic data 154 and roadwork data (historical, current and planned) 156. Current traffic data 154 may be based on web-cam data from, for example, local news stations and/or a transportation (and/or highway) department and may include current traffic flow data. Traffic data 152, 154 may include frequency and/or distance between stop lights, frequency of traffic stops, frequency of any sort of traffic activity (for example, traffic congestion, traffic jams, traffic stalls) and/or other traffic related data. Roadwork data 156 may include frequency of roadwork, time of day of roadwork, and/or whether the road is or will be closed, open or limited open during the roadwork. Roadwork data 156 may further include information regarding the effects of the roadwork on road quality, including road surface characteristics (e.g., bumpy, uneven, muddy), road surface materials (e.g., dirt, gravel, asphalt), road width, road pitch and/or other road quality characteristics. The traffic service 150 thus may provide traffic data for each possible route. The traffic data may vary with time of year, day of week and/or time of day, information that may be included in trip characteristics 126.

Crime/accident service 160 may include accident data (historical and current) 162 and crime data (historical and current) 164. The crime/accident service 160 may thus provide crime and/or accident data for locations near a possible route. The crime data 164 may correlate with one or more user characteristics (e.g., age, sex, ethnicity, socioeconomic status) 132, one or more vehicle characteristics 136 and/or one or more trip characteristics 126. For example, the crime data 164 may include victim characteristics that correspond to one or more user characteristics and may thus be used to determine a user's risk of becoming a crime victim. Similarly, the accident data 162 may correlate with one or more user characteristics 132, one or more vehicle characteristics 136 and/or one or more trip characteristics 126. For example, an accident may be more likely for a teenaged male driving a sports car on a weekend night than for a middle aged female driving a family vehicle on a weekday afternoon.

Weather service 170 may include historical weather data 172, current weather data 174 and predicted weather data 176. The weather service 170 may thus provide weather data along a possible route. For example, weather data may include frequency of weather alerts by location. The weather data associated with a possible route may correlate to time of year (a trip characteristic).

Geographic service 180 may include geographic data 182 and topographic data 184. Geographic data 182 may include regional attributes such as urban, suburban, rural, industrial, commercial, scenic and/or other regional attributes. Geographic data 182 may further include bodies of water and their locations, roads and their classifications (e.g., rural roads, town roads, city streets, state roads, freeways (highways), interstate roads), parks and recreational areas. Geographic data may be analyzed relative to type of travel such as vacation travel vs. commuting and or mode of travel such as walking vs. driving.

Topographic data 184 includes elevation data. Topographic data 184 may be utilized for generating weighted route recommendations, for example, for a walking trip. In this example, a user preference may be related to rate of change of elevation. In other words, a user may prefer a gradual incline or a steep incline. In another example, for a vehicle characteristic that includes towing a trailer, the rate of change of elevation may be utilized in determining the weighted route recommendation, for example, a recommended route may be configured to avoid steep hills.

Specialty service 190 may include alternative fuel availability data 192, bike path data 194 and walking path data 196. For example, if the vehicle characteristics include an alternative fuel vehicle, analyzing trip modifier(s) and generating an associated weighted route recommendation may include consideration of alternative fuel availability data 192. In other words, if the vehicle is an all-electric vehicle and the trip distance is greater than the range of the electric vehicle, a recommended route should include charging station(s). Bike path data 194 and walking path data 196 may include locations and attributes of dedicated bike paths and walking paths, respectively.

Other service 198 may include other data 199. Other data may include any data relevant to generating weighted route recommendations not otherwise included.

Thus, objective data (traffic service 150, crime/accident service 160, weather service 170, geographic service 180, specialty service 190 and other service 198) may include a range of data that may be utilized in generating weighted route recommendations. The specific data used may be selected (and analyzed) based on trip modifier(s) that include the user's prioritized travel factors and thus risk tolerance. Further, at least some of the objective data may correlate with the trip modifier(s). As a result, the generated weighted route recommendations may yield personalized route recommendations based on trip modifier(s) (e.g., user characteristics 132, travel factors 134 and their relative priorities, vehicle characteristics 136 and/or trip characteristics 126). The user may then select a route based on personalized recommendations that are based on objective data and the user's priorities.

Route personalization app 122 is configured to acquire selected objective data based, at least in part, on a provided user profile 140A, . . . , or 140N, trip characteristics 126 and/or possible route information generated by routing app 120. The selected objective data may be acquired for a number of points along each possible route. Initially, all of the selected objective data available for each possible route may be acquired. The acquired selected objective data may then be analyzed along the route and route portions where the objective data does not change or changes an amount less than a threshold, may be grouped into intervals. A length of an interval may be adaptive, i.e., may depend on the type of travel. For example, an interval related to a walking trip may be shorter than an interval related to a driving trip. Interval boundaries may be based on physical travel path boundaries. Boundaries include neighborhood boundaries, intersections of roads, edges of city blocks, state lines, and/or any other route boundary. For example, in a city, an interval may correspond to a city block and the associated boundary may correspond to an edge of the city block. In another example, for a freeway with a relatively long distance between exits, intervals may be a fraction of a mile (e.g., quarter mile). Intervals may have shorter lengths (i.e., correspond to finer gradations) when the associated objective data is changing and longer lengths (i.e., correspond to coarser gradations) when the associated objective data is not changing or is changing very little (i.e., is relatively static).

Routing personalization app 122 is further configured to analyze the acquired selected objective data based on trip modifiers in order to generate the weighted route recommendations. Trip modifiers typically include user profiles that include prioritized travel factors. For example, a user may rate safety as more important than distance in a prioritized grouping of travel factors for vacation travel. In another example, a user with a history of traffic violations may rate minimizing traffic stops as more important than travel time. Route personalization app 122 is configured to include such prioritizations when analyzing the objective data based on trip modifier(s) and generating the weighted route recommendations.

Route personalization app 122 may use one or more analytical techniques (including, but not limited to, statistical analyses) when analyzing the objective data based on trip modifiers. The analysis may be performed for each interval or for a group of intervals. Whether the analysis is performed for each interval or for a group of intervals may depend on trip modifier(s) and/or whether the related objective data for the interval or group of intervals changes. The analytical techniques may include, but are not limited to, standard deviation, Markov chains, Bayesian networks (“Bayes net”), linear regression models, discrete choice models, logistic regression, Probit regression, time series models and/or other analytical techniques configured to provide an ordered list of possible routes based on objective data and trip modifiers (including user priorities). The analytical techniques may include an optimal control theory type analysis (i e , minimizing or maximizing a cost function with constraints) where the cost function is based on relative priorities of travel factors included in a user profile. Thus, the analysis is configured to provide an optimal route based on possible routes, objective data and trip modifiers that include user priorities. The optimal route may be specific to the user, i.e., is personalized for that user. In other words, different users with different characteristics, preferences and/or priorities but with the same possible routes may receive different weighted route recommendations. Similarly, a same user who has selected different priorities may receive different weighted route recommendations according to the different priorities.

For some combinations of possible routes generated by routing app 120 and trip modifiers, none of the possible routes initially generated by routing app 120 may satisfy the trip modifiers including the prioritized travel factors. The route personalization app 122 may be configured to communicate with routing app 120 to adjust one or more possible route(s) to achieve a personalized route that does satisfy the trip modifiers. Such adjusting may be similar to dragging and dropping sections of a mapped route currently available in some mapping software (e.g., Google Maps, Yahoo! Maps). However, rather than the user performing the dragging and dropping, route adjustments via the route personalization app 122 are based on trip modifiers including user characteristics, preferences and priorities.

It should be noted that a personalized route that satisfies trip modifiers when a trip is being planned may not satisfy the trip modifiers when the actual travel occurs or may change while the user is travelling. For example, an accident may happen on the personalized route ahead of the user's current location. In another example, user behavior while travelling (for example, driving faster or slower than anticipated) may affect the weighted recommendations. Thus, the selected personalized route may no longer be the “best” route according to user characteristics, preferences and priorities. Trip monitor app 124 is configured to monitor user travel attributes such as travel speed and/or objective data such as current traffic data and current accident data. If the travel attributes differ from anticipated values and/or the objective data changes, the trip monitor app 124 is configured to communicate with the route personalization app 122 to initiate a reroute. The adjusted route may be generated based on prioritized travel factors, user characteristics, vehicle characteristics and/or trip characteristics and current objective data. In this manner, a new route or route adjustment may be provided that corresponds to a user's priorities, characteristics and/or preferences.

Thus, the route personalization app 122 is configured to generate weighted route recommendations for each route generated by routing app 120 based on trip modifiers. The resulting weighted route recommendations may then be displayed on user device 102, e.g., on display 114. The manner in which the weighted route recommendations are displayed may be based, at least in part on display preferences 138. Display preferences 138 may include simple composite relative indicators (relatively better, relatively poorer) or detailed data based on prioritized travel factors and related objective data. The composite relative indicators may also be displayed on or near a list of possible routes provided by the routing app 120. For example, a composite weight may be indicated by a color. In other words, if weighted route recommendations have been generated for three possible routes, a relatively better route may be indicated by the color green, a relatively poorer route may be indicated by the color red and a route with weight indicator(s) between relatively better and relatively poorer may be colored yellow. The colors may be overlaid on the route to which they correspond. Such colors are selected merely as an example; any visual indicator including symbols may be used.

In another example, symbols may be used to indicate route locations and/or intervals where a likelihood related to a user-prioritized travel factor may exceed a threshold. In other words, the symbols may represent likelihood that, for example, inclement weather, accident, crime or traffic jams may exceed a respective threshold. Thus, the user may be provided a visual indicator that corresponds to a prioritized travel factor (and the user risk tolerance).

In another example, detailed data may be provided for one or more intervals along each analyzed route. The detailed data may include statistics associated with the user's prioritized travel factors. For example, for a user profile that includes avoiding crime as a priority, detailed data may include crime statistics related to user characteristics, vehicle characteristics and/or trip characteristics. Thus, the detailed data may be displayed as an overlay for each interval. The detailed data may provide the user with a basis for each weighted route recommendation.

Thus, the weighted route recommendations may be overlaid onto the possible routes (and/or list of possible routes) generated by routing app 120. The overlay technique may be selected by the user via display preferences 138. Overlay techniques include but are not limited to HTML, Java, Javascript, Shockwave, Flash, HTML5 and/or other overlay techniques. The overlay may be configured as a mash up (i.e., a combination of web pages or web sites where data is acquired from a plurality of web pages or web sites and integrated to present a single unified display). For example, a mash up may include displaying the possible routes from the routing app 120 overlaid with detailed data and/or color corresponding to weighted route recommendations.

Thus, the method and system consistent with the present disclosure are configured to provide weighted recommendations regarding a travel route to a user based on user-provided trip modifier(s) and a plurality of objective data. The weighted recommendations are configured to incorporate the user's risk tolerance. The trip modifiers may include, but are not limited to, trip characteristics, user characteristics, user prioritized travel factors and vehicle characteristics. The objective data may include, but is not limited to, traffic data, crime data, accident data, weather data, geographic data, specialty data, and/or other objective data. The objective data may include historical, current and/or future (predicted or planned) data. The route personalization app 123 is configured to analyze the objective data based on the trip modifiers to generate the weighted route recommendations and to display the routes with indicators corresponding to the weighted route recommendations. The user may thus be provided personalized route recommendations that are based at least in part on the user's risk tolerance.

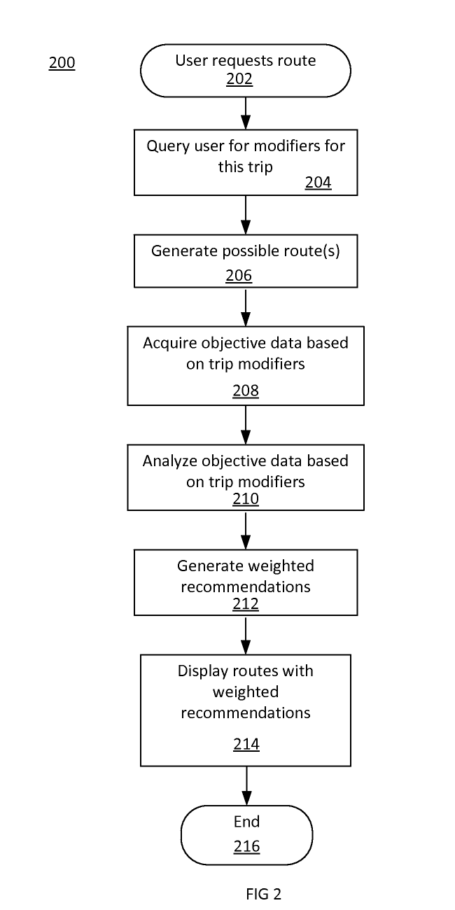

FIG. 2 illustrates a flow chart 200 of exemplary operations of a user device consistent with various embodiments of the present disclosure. The operations of flow chart 200 may be performed by a user device, e.g., user device 102. In particular flow chart 200 depicts exemplary operations configured to personalize a travel route, consistent with the present disclosure. Program flow may begin 202 when a user requests a route. Operation 202 may include the user providing a start location and one or more destinations to a routing app. Operation 204 may include asking the user for associated trip modifiers. For example, the trip modifiers may include trip characteristics, user characteristics, prioritized travel factors and/or vehicle characteristics. At least some of the trip modifiers may be included in a previously stored user profile. Possible route(s) may be generated at operation 206. The possible routes may be based on the start location and the one or more destinations provided in operation 202.

Operation 208 may include acquiring objective data based on the trip modifiers. The objective data may be acquired from a plurality of objective services. Operation 210 may include analyzing the objective data based on the trip modifiers. Weighted recommendations may be generated for each possible route at operation 212. The possible routes overlaid with weighted recommendation indicators may be displayed at operation 214. Program flow may end at operation 216. Thus, personalized route recommendations may be provided to a user based on trip modifiers and objective data.

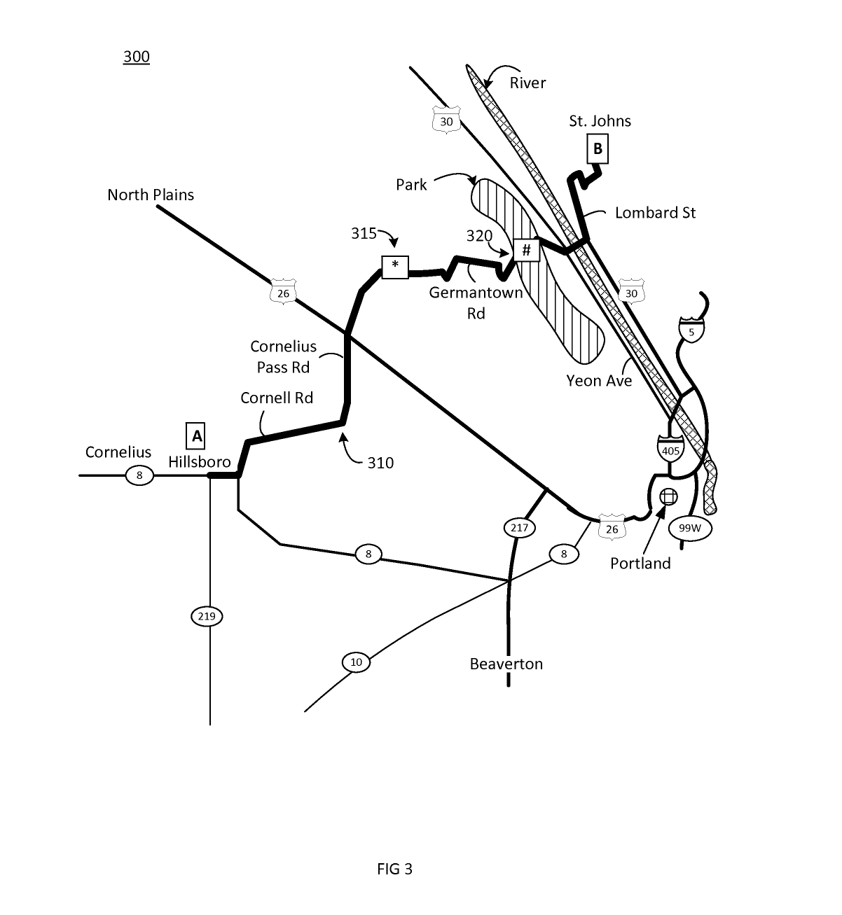

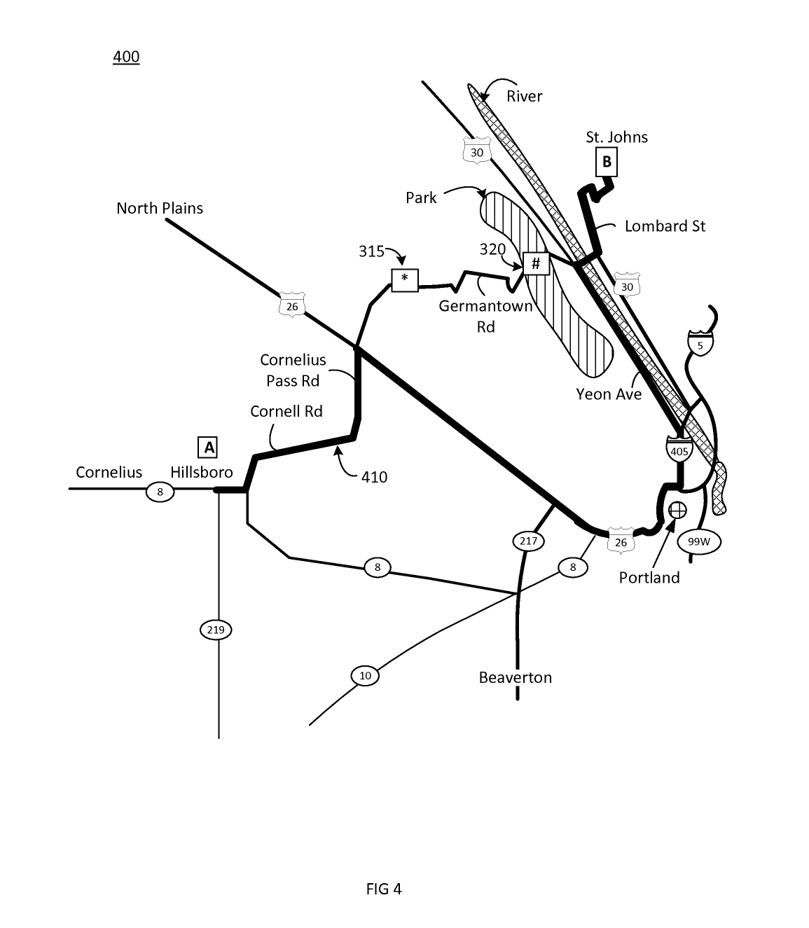

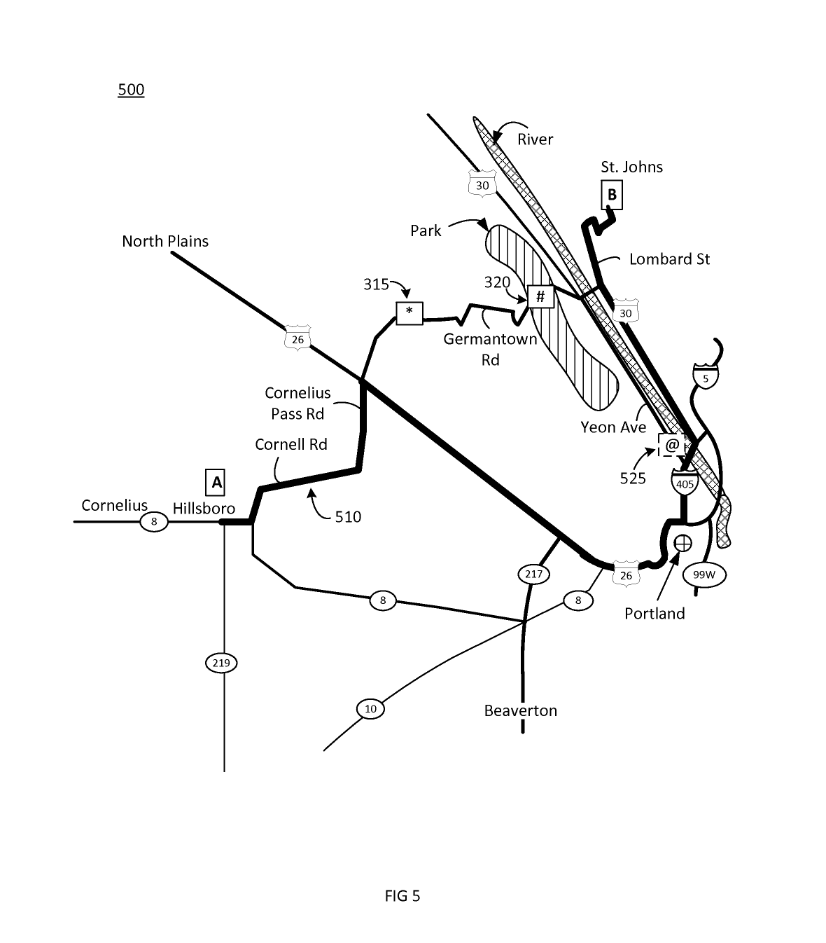

FIGS. 3, 4 and 5 illustrate an example of route personalization consistent with various embodiments of the present disclosure. FIG. 3 illustrates a map 300 showing roads between Hillsboro, Oreg. (starting location) and St. Johns, Portland, Oreg. (destination). It should be noted that the maps of FIGS. 3, 4, and 5 are simplified (i.e., not all roads are shown) for ease of illustration. A first possible travel route 310 is highlighted in bold on map 300. Other possible travel routes exist and a second and third possible travel route are highlighted in FIG. 4 and FIG. 5, respectively. The first possible travel route 310 may be generated by a routing app. Travel route 310 starts on Route 8 in Hillsboro, proceeds along Cornell Road, then along Cornelius Pass Road, crosses Route 26, then proceeds along Germantown Road, then onto Route 30 over a bridge and then on to Lombard Street and to the destination in St. Johns, Portland, Oreg. Travel route 310 appears to be a route that provides a relatively shortest distance between the starting location and the destination.

Continuing with this example, the user has relatively highly prioritized avoiding inclement weather along the route and avoiding crime areas in his/her user profile for this trip. Travel route 310 has been annotated with weighted recommendation indicators 315, 320, generated based on the user profile including the user's prioritized travel factors. Indicator 315 corresponds to a location where snow squalls are likely to occur on the anticipated date of travel. Indicator 320 corresponds to an area with a relatively high crime risk based on analysis of crime data for individuals whose characteristics correspond to the user's characteristics and/or user's vehicle characteristics. Although travel route 310 accommodates travel from the starting location to the destination, it is not personalized to the user's priorities. In other words, travel route 310 does not satisfy the user's risk tolerance. Based on the display of the possible route 310 with the weighted recommendation indicators 315, 320, the user may choose not to select route 310 and may consider another possible route.

FIG. 4 illustrates a map 400 corresponding to map 300 of FIG. 3 showing roads between Hillsboro, Oreg. and St. Johns, Portland, Oreg. A second possible travel route 410 is shown in bold. The second possible travel route 410 may be generated by a routing app. Travel route 410 starts on Route 8 in Hillsboro, proceeds along Cornell Road, then along Cornelius Pass Road, onto Route 26, proceeds along Route 26 then onto Route 405, then along Yeon Avenue, then onto Route 30 over a bridge and then on to Lombard Street and to the destination. Travel route 410 avoids the location 315 with the risk of inclement weather and the location 320 with unacceptable crime risk according to the analysis of crime data and the trip modifiers including the user's prioritized travel factors. Thus, the user may select travel route 410, the second possible route provided by the routing app, based on the weighted recommendation provided as a result of analyzing objective data based on user selected and prioritized trip modifiers.

FIG. 5 illustrates a map 500 corresponding to map 300 of FIG. 3 and map 400 of FIG. 4 showing roads between Hillsboro, Oreg. and St. Johns, Portland, Oreg. A third possible travel route 510 is shown in bold. Travel route 510 may be generated by a routing app while the user is en route. For example, trip monitor app and/or route personalization app may receive an indication that a route change is desirable because an accident has occurred on the selected travel route (i.e., travel route 410) ahead of the user's current location. For example, current accident data may indicate that an accident has occurred on Yeon Ave. The accident is indicated by symbol 525 on Yeon Ave. Travel route 510 starts on Route 8 in Hillsboro, proceeds along Cornell Road, then along Cornelius Pass Road, onto Route 26, proceeds along Route 26 (similar to travel route 410) then diverges from travel route 410 onto Route 405, over a bridge, then onto Route 30 and then on to Lombard Street and the destination, avoiding Yeon Ave. Travel route 510 is configured to avoid the risk of inclement weather indicated by symbol 315, the risk of the user being a crime victim indicated by symbol 320 and the accident indicated by symbol 525. Thus, the user may be rerouted while still satisfying the user's prioritized travel factors.

While FIG. 2 illustrates various operations according to various embodiments, it is to be understood that not all of the operations depicted in FIG. 2 are necessary for other embodiments. Indeed, it is fully contemplated herein that in other embodiments of the present disclosure, the operations depicted in FIG. 2 and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

Any of the operations described herein may be implemented in a system that includes one or more storage mediums having stored thereon, individually or in combination, instructions that when executed by one or more processors perform the methods. Here, the processor may include, for example, a server CPU, a user device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions.

Other embodiments may be implemented as software modules executed by a programmable control device. The storage medium may be non-transitory.

While the foregoing is prided as exemplary system architectures and methodologies, modifications to the present disclosure are possible. For example, memory, e.g., user device memory 112, may comprise one or more of the following types of memory: semiconductor firmware memory, programmable memory, non-volatile memory, read only memory, electrically programmable memory, random access memory, flash memory, magnetic disk memory, and/or optical disk memory. Either additionally or alternatively user device memory 112 may comprise other and/or later-developed types of computer-readable memory.

User device 102 may be configured to communicate with network 104 and or objective data services using a variety of communication protocols. The communications protocols may include but are not limited to wireless communications protocols, such as Wi-Fi, Bluetooth, 3G, 4G, RFID, NFC and/or other communication protocols. The communications protocols may comply and/or be compatible with other related Internet Engineering Task Force (IETF) standards.

The Wi-Fi protocol may comply or be compatible with the 802.11 standards published by the Institute of Electrical and Electronics Engineers (IEEE), titled “IEEE 802.11-2007 Standard, IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications” published, Mar. 8, 2007, and/or later versions of this standard.

The NFC and/or RFID communication signal and/or protocol may comply or be compatible with one or more NFC and/or RFID standards published by the International Standards Organization (ISO) and/or the International Electrotechnical Commission (IEC), including ISO/IEC 14443, titled: Identification cards—Contactless integrated circuit cards—Proximity cards, published in 2008; ISO/IEC 15693: Identification cards—Contactless integrated circuit cards—Vicinity cards, published in 2006; ISO/IEC 18000, titled: Information technology—Radio frequency identification for item management, published in 2008; and/or ISO/IEC 18092, titled: Information technology—Telecommunications and information exchange between systems—Near Field Communication—Interface and Protocol, published in 2004; and/or related and/or later versions of these standards.

The Bluetooth protocol may comply or be compatible with the 802.15.1 standard published by the IEEE, titled “IEEE 802.15.1-2005 standard, IEEE Standard for Information technology—Telecommunications and information exchange between systems—Local and metropolitan area networks—Specific requirements Part 15.1: Wireless Medium Access Control (MAC) and Physical Layer (PHY) Specifications for Wireless Personal Area Networks (W Pans)”, published in 2005, and/or later versions of this standard.

The 3G protocol may comply or be compatible with the International Mobile Telecommunications (IMT) standard published by the International Telecommunication Union (ITU), titled “IMT-2000”, published in 2000, and/or later versions of this standard. The 4G protocol may comply or be compatible with IMT standard published by the ITU, titled “IMT-Advanced”, published in 2008, and/or later versions of this standard.

User device 102 may be configured to communicate with network 104 and or objective data services using a selected packet switched network communications protocol. One exemplary communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard. Alternatively or additionally, mobile device 102 may be capable of communicating with a network 104 using an X.25 communications protocol. The X.25 communications protocol may comply or be compatible with a standard promulgated by the International Telecommunication Union-Telecommunication Standardization Sector (ITU-T). Alternatively or additionally, user device 102 may be configured to communicate with network 104 and or objective data services, using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, user device 102 may be configured to communicate with network 104 and or objective data services, using an Asynchronous Transfer Mode (ATM) communications protocol. The ATM communications protocol may comply or be compatible with an ATM standard published by the ATM Forum titled “ATM-MPLS Network Interworking 1.0” published August 2001, and/or later versions of this standard. Of course, different and/or after-developed connection-oriented network communication protocols are equally contemplated herein. “Circuitry”, as used in any embodiment herein, may comprise, for example, singly or in any combination, hardwired circuitry, programmable circuitry, state machine circuitry, and/or firmware that stores instructions executed by programmable circuitry. An application (“app”) and/or module, as used in any embodiment herein, may be embodied as circuitry. The circuitry may be embodied as an integrated circuit, such as an integrated circuit chip.

Thus, the present disclosure provides a method and system for route personalization. The method and system are configured to provide a user a personalized travel route from a starting location to at least one destination. The method and system are configured to provide weighted recommendations regarding a travel route to a user based on user-provided trip modifier(s) including prioritized travel factors and a plurality of objective data. The personalized travel route is configured to provide the user a travel route that accommodates a user's prioritized travel factors. The user may thus proceed along the personalized route confident that the user's risk tolerance has been accommodated.

According to one aspect there is provided a method. The method may include requesting that a user of a computing device provide a trip modifier in response to a request from the user to map a route from a first location to a second location; acquiring objective data related to the trip modifier for at least one possible route from the first location to the second location; generating a weighted route recommendation associated with each possible route based on the acquired objective data and the trip modifier; and displaying each possible route and its associated weighted route recommendation on the computing device, wherein the trip modifier comprises at least one user characteristic and each weighted route recommendation is configured to provide a personalized route recommendation to the user for the respective associated possible route.

According to another aspect there is provided a system. The system may include a computing device configured to: request that a user of the computing device provide a trip modifier in response to a request from the user to map a route from a first location to a second location; acquire objective data related to the trip modifier for at least one possible route from the first location to the second location; generate a weighted route recommendation associated with each possible route based on the acquired objective data and the trip modifier; and display each possible route and its associated weighted route recommendation on the computing device, wherein the trip modifier comprises at least one user characteristic and each weighted route recommendation is configured to provide a personalized route recommendation to the user for the respective associated possible route.

According to another aspect there is provided a system. The system may include one or more storage mediums having stored thereon, individually or in combination, instructions that when executed by one or more processors result in the following operations including: requesting that a user of a computing device provide a trip modifier in response to a request from the user to map a route from a first location to a second location; acquiring objective data related to the trip modifier for at least one possible route from the first location to the second location; generating a weighted route recommendation associated with each possible route based on the acquired objective data and the trip modifier; and displaying each possible route and its associated weighted route recommendation on the computing device, wherein the trip modifier comprises at least one user characteristic and each weighted route recommendation is configured to provide a personalized route recommendation to the user for the respective associated possible route.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-15. (canceled)

16. A method comprising:
requesting that a user of a computing device provide a trip modifier in response to a request from the user to map a route from a first location to a second location;
acquiring objective data related to the trip modifier for at least one possible route from the first location to the second location;
generating a weighted route recommendation associated with each possible route based on the acquired objective data and the trip modifier; and
displaying each possible route and its associated weighted route recommendation on the computing device,
wherein the trip modifier comprises at least one user characteristic and each weighted route recommendation is configured to provide a personalized route recommendation to the user for the respective associated possible route.

17. The method of claim 16, further comprising:
analyzing the acquired objective data based on the trip modifier, wherein the generating is based on a result of the analysis.

18. The method of claim 16, further comprising:
repeating the acquiring, generating and displaying in response to an indication that a selected route has become compromised, wherein the repeating is configured to yield an alternate personalized route recommendation.

19. The method of claim 16, wherein the trip modifier comprises at least one prioritized travel factor and the personalized route recommendation is configured to reflect the user's risk tolerance.

20. The method of claim 16, wherein the trip modifier comprises at least one of a trip characteristic, a user characteristic, a user prioritized travel factor and a vehicle characteristic.

21. The method of claim 16, wherein the objective data comprises at least one of traffic data, crime data, accident data, weather data and specialty data.

22. The method of claim 19, wherein the at least one prioritized travel factor is selected from a group of travel factors comprising safety, travel time, travel distance, likelihood of criminal activity, likelihood of travel delays, likelihood of inclement weather, risk of accident and frequency of traffic stops.

23. A system, comprising:
a computing device configured to:
request that a user of the computing device provide a trip modifier in response to a request from the user to map a route from a first location to a second location;
acquire objective data related to the trip modifier for at least one possible route from the first location to the second location;
generate a weighted route recommendation associated with each possible route based on the acquired objective data and the trip modifier; and
display each possible route and its associated weighted route recommendation on the computing device,
wherein the trip modifier comprises at least one user characteristic and each weighted route recommendation is configured to provide a personalized route recommendation to the user for the respective associated possible route.

24. The system of claim 23, wherein the computing device is further configured to:
analyze the acquired objective data based on the trip modifier, wherein the generating is based on a result of the analysis.

25. The system of claim 23, wherein the computing device is further configured to:
repeat the acquiring, generating and displaying in response to an indication that a selected route has become compromised, wherein the repeating is configured to yield an alternate personalized route recommendation

26. The system of claim 23 wherein the trip modifier comprises at least one prioritized travel factor and the personalized route recommendation is configured to reflect the user's risk tolerance.

27. The system of claim 23, wherein the trip modifier comprises at least one of a trip characteristic, a user characteristic, a user prioritized travel factor and a vehicle characteristic.

28. The system of claim 23, wherein the objective data comprises at least one of traffic data, crime data, accident data, weather data and specialty data.

29. A system comprising one or more storage mediums having stored thereon, individually or in combination, instructions that when executed by one or more processors result in the following operations comprising:
requesting that a user of a computing device provide a trip modifier in response to a request from the user to map a route from a first location to a second location;
acquiring objective data related to the trip modifier for at least one possible route from the first location to the second location;
generating a weighted route recommendation associated with each possible route based on the acquired objective data and the trip modifier; and
displaying each possible route and its associated weighted route recommendation on the computing device,
wherein the trip modifier comprises at least one user characteristic and each weighted route recommendation is configured to provide a personalized route recommendation to the user for the respective associated possible route.

30. The system of claim 29, wherein the instructions that when executed by one or more processors results in the following additional operations:
analyzing the acquired objective data based on the trip modifier, wherein the generating is based on a result of the analysis.

31. The system of claim 29, wherein the instructions that when executed by one or more processors results in the following additional operations:
repeating the acquiring, generating and displaying in response to an indication that a selected route has become compromised, wherein the repeating is configured to yield an alternate personalized route recommendation.

32. The system of claim 29, wherein the trip modifier comprises at least one prioritized travel factor and the personalized route recommendation is configured to reflect the user's risk tolerance.

33. The system of claim 29, wherein the trip modifier comprises at least one of a trip characteristic, a user characteristic, a user prioritized travel factor and a vehicle characteristic.

34. The system of claim 29, wherein the objective data comprises at least one of traffic data, crime data, accident data, weather data and specialty data.

35. The system of claim 29, wherein the at least one prioritized travel factor is selected from a group of travel factors comprising safety, travel time, travel distance, likelihood of criminal activity, likelihood of travel delays, likelihood of inclement weather, risk of accident and frequency of traffic stops.
